(19) United States
(12) Patent Application Publication
(10) Pub. No.: US 2008/0268102 A1
(43) Pub. Date: Oct. 30, 2008

(54) Method of supplementing an edible aqueous liquid composition with two or more mineral salts

(75) Inventors: Michel Mellema, Vlaardingen (NL); Andries Moret, Vlaardingen (NL); Farley Ferdinand Tio, Vlaardingen (NL); Martinus Bernardus Johannus van der Vlugt, Delft (NL)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a Unilever

(21) Appl. No.: 12/150,035

(22) Filed: Apr. 24, 2008

(30) Foreign Application Priority Data
Apr. 27, 2007 (EP) EP07107089
Jun. 5, 2007 (EP) EP07109589

(51) Int. Cl. A23L 1/304

(52) U.S. Cl. 426/74

(57) ABSTRACT

One aspect of the invention relates to a method for producing an edible aqueous liquid composition that has been supplemented with a first mineral selected from the group of metals consisting of calcium, magnesium, potassium, zinc, copper, iron, manganese and a second mineral, different from the first mineral, that is selected from the same group of metals.

Another aspect of the present inventions relates to a reconstitutable powder containing:
0.01-3 mmole of the first mineral per gram of powder;
0.02-4 mmole of the second mineral per gram of powder;
0.02-8 mmole of acid per gram of powder, said acid being selected from the group consisting of citric acid, tartaric acid, malic acid, phosphoric acid and combinations thereof;
0.02-0.99 g of soy protein per gram of powder; and
less than 10 wt. % of water.

The reconstitutable powder is characterised in that 25 grams of the powder can be reconstituted with 1 kg of water to yield an edible aqueous liquid that will not form a salt sediment of the first and/or second mineral when stored under ambient, quiescent conditions for 3 months or longer.

### TECHNICAL FIELD OF THE INVENTION

The present invention relates to a method of supplementing an edible aqueous liquid composition with two or more mineral salts, including a first mineral selected from the group of metals consisting of calcium, magnesium, potassium, zinc, copper, iron, manganese and a second mineral, different from the first mineral, that is selected from the same group of metals.

### BACKGROUND OF THE INVENTION

From a nutritional perspective it is desirable to add minerals to foodstuffs and beverages or to provide nutritional supplements containing high levels of minerals. Examples of minerals with significant nutritional value include calcium, magnesium, potassium, zinc, copper, iron, manganese. In order to ensure that these minerals are sufficiently bio-available it is generally preferred to include these minerals in the form of a bio-available salt.

It has been found that if the use of water-soluble mineral salts in water-containing, especially water-continuous edible products, is accompanied by an objectionable metallic off-taste. This problem may be overcome by using a water-insoluble mineral salt. However, since these mineral salts are water-insoluble, they tend to precipitate rapidly during and after product manufacture. The resulting sediment adversely affects consumer acceptance of these products. Furthermore, if the product is not vigorously shaken before use to redisperse the sediment, at best only a part of the mineral content of the product will be consumed.

Accordingly, there is a need for a method that can suitably be used to produce fortified edible aqueous liquid compositions having a high content of bio-available minerals, that do not give rise to off-taste and that do not sediment during storage.

It is known in the art to produce an edible aqueous liquid containing bio-available calcium that does not give rise to sedimentation during storage. U.S. Pat. No. 6,811,800 describes a process for the preparation of calcium fortified mammal milk and soy milk, said process comprising the addition of a metastable concentrated soluble calcium solution. The concentrated soluble calcium solution is prepared from the following starting materials:

| | |
|---|---|
| Calcium hydroxide | 7.84 wt. % |
| Citric acid | 7.32 wt. % |
| Malic acid | 7.50 wt. % |
| Water | 77.24 wt. % |

The meta-stable calcium solution is prepared by dispersing the calcium hydroxide in 90% of the water at 3° C. and adding a dry blend of the citric and malic acids as well as the remaining water, followed by mixing until a clear solution is formed. The product is said to achieve high levels of soluble calcium and product stability without requiring an added stabiliser or chelating agent.

WO 02/069743 describes a method for producing a calcium fortified beverage, comprising:
a) blending an aqueous solution of a calcium containing base and an acid to form a blended acid/base solution;
b) retaining the blended acid/base solution in an in-line reaction tube for a controlled amount of time sufficient to produce a calcium salt solution and to avoid precipitation of the calcium salt; and
c) continuously adding the calcium salt solution from the in-line reaction tube to a beverage, thereby producing a calcium fortified beverage.

According to the international patent application the aforementioned method can suitably be used to control the relative proportions of mono-, di-, and tri-valent calcium citrate. It is asserted that there is a natural transformation tendency from low-valent calcium citrate to high valent calcium citrate which is the most stable form and the least soluble form. The method described in the international patent application is said to avoid the production of tri-valent calcium citrate to effectively reduce the presence of precipitating salts.

The aforementioned methodologies can suitably be used to produce storage stable beverages that contain appreciable levels of bio-available calcium and that do not suffer from calcium-associated off-flavours by incorporating therein a clear meta-stable calcium solution. However, these methods are not suitable for producing a clear meta-stable solution of two or more mineral, wherein each of the minerals is present in a meta-stable dissolved state.

The aforementioned prior art methods rely on the formation of a clear meta-stable calcium solution that is added to the enduse product before precipitation of water-insoluble calcium salt occurs. If two different water-insoluble mineral salts are simultaneously processed in accordance with the aforementioned methodologies, no clear meta-stable solution is obtained because the minerals will reach their soluble meta-stable state at different moments in time. Thus, if one component has reached its soluble, meta-stable state, at least a fraction of the other component is either in its original water-insoluble state or has already progressed from the meta-stable state to a stable, water-insoluble state.

The problem addressed by the present invention is to provide a method that enables preparation of a clear solution of two different minerals selected from the group calcium, magnesium, potassium, zinc, copper, iron and manganese, which solution can advantageously be used to deliver appreciable levels of these minerals in a bio-available form to edible liquid products by incorporating this clear solution in the enduse product before precipitation occurs.

### SUMMARY OF THE INVENTION

The inventors have solved the aforementioned problem by providing a method in which a water insoluble carbonate salt of a first mineral is added to an acidic aqueous liquid and allowed to react under decarboxylation to form a water soluble salt, followed by the addition of a water-insoluble carbonate salt of a second mineral which is also allowed to react under decarboxylation to form a water soluble salt, thus creating a metastable clear solution of both minerals, following which sedimentation of water-insoluble salts of the first and/or second mineral is prevented by adding a biopolymer and/or by increasing the pH.

Thus, the present invention provides a method for producing an edible aqueous liquid composition that has been supplemented with a first mineral selected from the group of metals consisting of calcium, magnesium, potassium, zinc, copper, iron, manganese and a second mineral, different from the first mineral, that is selected from the same group of metals, said method comprising the successive steps of:
providing an acidic aqueous liquid having a pH in the range of 2.0-4.5 and containing dissolved acid that is capable of forming a water-insoluble salt with the first mineral as well as with the second mineral;
adding to the acidic aqueous liquid a solid water-insoluble carbonate salt of the first mineral;
allowing the carbonate salt to dicarboxylate until at least 50 wt. % of the carbon dioxide potential has been released;
adding to the aqueous liquid a solid water-insoluble carbonate salt of the second mineral; and
adding a biopolymer and/or increasing the pH by at least 0.5 pH units to a pH of more than 3.4 when both the water-insoluble carbonate salt of the first mineral and the water-insoluble carbonate salt of the second mineral have been converted into dissolved salts and before sedimentation occurs of a water-insoluble salt of the first mineral or of a water-insoluble salt of the second mineral.

In the present method, the order of addition of the carbonate salts of the first and the second mineral is chosen in such a way that the carbonate salt that reacts most slowly with the acid to form a water-insoluble mineral salt is added first. Thus, it can be ensured that no sedimentation of water-insoluble salt of the first mineral occurs before the carbonate salt of the second mineral has reacted sufficiently to produce a clear solution. By adequate timing of the moment of addition of the carbonate salt of the second mineral, it can be ensured that both the first and the second mineral salts are fully dissolved at the same time, thus yielding a metastable clear solution. In accordance with the present invention transformation of the mineral salts within the metastable clear solution to less soluble, more stable mineral salts is prevented by adding a biopolymer and/or by increasing the pH.

### DETAILED DESCRIPTION OF THE INVENTION

Accordingly, the present invention provides a method for producing an edible aqueous liquid composition that has been supplemented with a first mineral selected from the group of metals consisting of calcium, magnesium, potassium, zinc, copper, iron, manganese and a second mineral, different from the first mineral, that is selected from the same group of metals, said method comprising the successive steps of:
a) providing an acidic aqueous liquid having a pH in the range of 2.0-4.5 and containing dissolved acid that is capable of forming a water-insoluble salt with the first mineral as well as with the second mineral;
b) adding to the acidic aqueous liquid a solid water-insoluble carbonate salt of the first mineral;
c) allowing the carbonate salt to dicarboxylate until at least 50%, preferably at least 80% of the carbon dioxide potential has been released;
d) adding to the aqueous liquid a solid water-insoluble carbonate salt of the second mineral; and
e) adding a biopolymer and/or increasing the pH by at least 0.5 pH units to a pH of more than 3.4 when both the water-insoluble carbonate salt of the first mineral and the water-insoluble carbonate salt of the second mineral have been converted into dissolved salts and before sedimentation occurs of a water-insoluble salt of the first mineral or of a water-insoluble salt of the second mineral.

The term “edible aqueous liquid composition” as used herein encompasses liquid foodstuffs, liquid nutritional compositions, liquid pharmaceutical compositions as well as beverages. Examples of liquid foodstuffs that are encompassed by the term “edible aqueous liquid composition” include dressings, pourable yogurt, soups, sauces etc. According to a preferred embodiment, the “edible aqueous liquid composition” is a beverage, especially a proteinaceous beverage containing at least 0.1 wt. %, more preferably at least 0.3 wt. % and most preferably at least 1 wt. % of protein.

The term “protein” as used herein encompasses intact as well as hydrolysed protein. The protein may be undenatured or denatured. It is also within the scope of the present invention to employ a blend of denatured and undenatured protein and/or of hydrolysed or non-hydrolysed protein.

The term “carbon dioxide potential” refers to the total amount of carbon dioxide that is contained in the water-insoluble carbonate salt and that can be released therefrom by chemical decarboxylation.

Whenever reference is made herein to a (metastable) clear solution, what is meant is that both the first mineral and the second mineral are completely dissolved.

In accordance with the present invention both the water-insoluble carbonate salt of the first mineral and the water-insoluble carbonate salt of the second mineral are converted into dissolved salts during step e). Here by “dissolved salts” it is meant that these salts are present in a form that does not scatter light and that does not sediment. This is achieved if a salt is dissolved at a molecular level or if it is present in the form of extremely small particles, i.e. particles having a diameter of less than 50 nm, more preferably of less than 5 nm. Most preferably, the dissolved salts are molecularly dissolved.

The present method comprises the addition of solid water-insoluble carbonate salts. In accordance with the present invention these water-insoluble carbonate salts are added in an amount that exceeds the maximum solubility of these carbonate salts in the aqueous liquid to which they are added. According to a preferred embodiment, both the water-insoluble carbonate salt of the first mineral and the water-insoluble salt of the second mineral are added in an amount that, under the conditions employed during the addition, exceeds the solubility of that particular salt in the aqueous liquid to which it is added by at least 10%, preferably by at least 25%. Here the solubility of the water-insoluble carbonate salt refers to the instant solubility of said carbonate salt upon addition.

Typically, the carbonate salts of the first mineral and the second mineral employed in accordance with the present invention have a solubility in distilled water of 25° C. and pH 7 of less than 3 g/l, preferably of less than 1 g/l, and/or a degree of ionisation at 0.03 mol/l and pH 4.5 of less than 95%, preferably of less than 70%. Most preferably, the carbonate salts of the two minerals meet both the solubility and the ionisation criterion. Here the degree of ionisaton refers to the molar fraction of the carbonate salt that is present in dissociated form.

As explained herein before, in the present method the first solid carbonate salt to be added is the solid carbonate salt that reacts most slowly with the acid to form a metastable dissolved salt. The reaction rate between the carbonate salt and the acid is determined by a number of factors including the type of mineral contained in the salt and the size of the salt particles. Minerals whose carbonate salts react relatively slowly with acid include Mg, Zn, Cu, Fe and Mn. Consequently, in a preferred embodiment the first mineral is selected from this group of metals. Most preferably, the first mineral employed in the present method is Mg.

Since the carbonate salts of Ca and K react relatively fast with acid, it is preferred to employ these metals as the second mineral. Most preferably, the second mineral is Ca.

As mentioned above, also particle size of the solid carbonate salt influences the rate at which this carbonate salt reacts with the acid. Thus, it may be ensured that the carbonate salt of the first mineral reacts more slowly than the carbonate salt of the second mineral by employing a carbonate salt of the first mineral that has larger particle size than the carbonate salt of the second mineral. Accordingly, in another preferred embodiment, the solid water-insoluble carbonate salt of the first mineral that is added during step b) has a number weighted mean particle size that is at least 100% larger, preferably at least 500% larger than the number weighted mean particle size of the solid water-insoluble carbonate salt of the second mineral that is added during step d).

Although the carbonate salt of the first mineral reacts slower with the acid than the carbonate salt of the second mineral, this does not necessarily mean that the duration of combined steps b) and c) exceeds that of combined steps d) and e) as the addition of the carbonate salt of the second mineral may commence before the carbonate salt of the first mineral has been completely converted into a completely dissolved salt. Typically, however, the duration of the combined step b) and c) exceeds the duration of the combined steps d) and e) up to the addition of the biopolymer and/or the pH increase.

The acid employed in the present method is suitably selected from the group consisting of citric acid, tartaric acid, malic acid, phosphoric acid and combinations thereof. Even more preferably, the acid is an organic acid selected from the group consisting of citric acid, tartaric acid, malic acid and combinations thereof. Most preferably, the organic acid is citric acid. According to a particularly preferred embodiment, the acidic aqueous liquid employed in step a) only contains the acid in dissolved form.

In accordance with a preferred embodiment of the present method, the first mineral is added in step b) in an amount of at least 5 mmole per kg, preferably of 20-600 mmole per kg, most preferably of 200-300 mmole per kg. Expressed differently, the first mineral is advantageously added in step b) in an amount of at least 0.4 g/kg, preferably of 1.5-50 g/kg, most preferably 13-30 g/kg.

Likewise, the second mineral is preferably added in step b) in an amount of at least 10 mmole per kg, preferably of 30-800 mmole per kg, most preferably of 300-450 mmole per kg. Expressed differently, the second mineral is advantageously added in step b) in an amount of at least 0.5 g/kg, preferably of 2-80 g/kg, most preferably of 15-40 g/kg.

In the present method acid may be added after step a) and before step d) in order to ensure that sufficient acid is present in the aqueous liquid to convert the carbonate salt of the second mineral into a fully dissolved salt. Preferably, however, sufficient acid is present in the aqueous liquid of step a) to convert both the carbonate salt of the first mineral and the carbonate salt of the second mineral into fully dissolved salts. According to another preferred embodiment, the combined molar amount of the solid water-insoluble carbonate salt of the first mineral and the solid water-insoluble carbonate salt of the second mineral that are added during steps b) and d) is between 10 and 150%, preferably between 50 and 115% of the molar amount of acid contained in the acidic aqueous liquid of step a).

Steps a) to e) of the present method are typically carried out at a temperature below 70° C., preferably below 50° C. Usually, the temperature employed during these steps exceeds 0° C., preferably it exceeds 6° C.

As mentioned herein before, during the execution of steps a) to e), additional acid may be added. In addition, acid or lye may be added to adjust the pH. Preferably, during steps a) to d) of the present method, pH is maintained within the range of 2.0-4.5. Most preferably, pH is maintained within the range of 2.5-4.0.

Although the inventors do not wish to be bound by theory it is believed that the addition of a biopolymer to the metastable clear solution stabilises the dissolved salts of the first and second mineral in that the charged groups of the biopolymer somehow complex charged mineral salts. As a result, these mineral salts are kept in suspension due their association to said biopolymer. Examples of biopolymers that may suitably be used in accordance with the invention include protein and anionic polysaccharides. According to one preferred embodiment the protein is milk protein or soy protein, soy protein being particularly preferred. The anionic polysaccharide employed in the present method is advantageously selected from the group consisting of pectin, carrageenan, alginate, carboxymethyl cellulose, xanthan, gellan gum and combinations thereof, pectin being most preferred. It is noted that pectin may be added in the form of isolated, purified pectin but also in the form of a pectin containing material, such as fruit. Most preferably, the step e) comprises the combined addition of protein and anionic polysaccharide, e.g. soy protein and pectin.

Typically, in step e) the biopolymer is added in an amount of at least 1 g/l. Most preferably, the biopolymer is added in an amount of 5-100 g/l. It should be understood that in accordance with the present invention the addition of the biopolymer is achieved by combining the aqueous liquid containing the two dissolved mineral salts with a composition containing the biopolymer. Thus, the present invention also encompasses a method in which addition of the biopolymer is achieved by introducing the metastable aqueous solution of the two minerals into a biopolymer containing liquid. As a matter of fact, it is preferred to carry out the process in this fashion.

The metastable clear solution may also be stabilised by increasing the pH of the solution. According to a preferred embodiment, said solution is stabilised in step e) of the present method by increasing the pH to at least 4.0, most preferably to at least 4.2. According to another preferred embodiment, in step e) the pH is increased by at least 0.8 pH units, most preferably by at least 1.0 pH units.

According to another preferred embodiment of the present method fruit solids are added together with or after the addition of the biopolymer. Typically, fruit solids are added in an amount of 0.05-15%, preferably of 1-5% by weight of the final edible aqueous liquid composition. It is believed that the pectin contained in the fruit solids helps to stabilise the edible aqueous liquid composition against sedimentation of mineral salt.

As explained herein before, in accordance with the present invention a metastable aqueous solution containing dissolved salts of the first and the second mineral is formed during step e). If no biopolymer is added and if the pH is not adjusted to above pH 3.4, this metastable solution will start forming a sediment over time. Indeed, the intermediate product obtained from step d) in the present process is typically characterised in that sedimentation of mineral salts will occur if the product is kept under quiescent conditions at a temperature of 20° C. for up to 24 hours. As a matter of fact, usually at least 5% by weight of the first mineral and/or a least 5% by weight of the second mineral sediments if the intermediate product is kept under quiescent conditions at a temperature of 20° C. for up to 24 hours.

The present process enables the preparation of an edible aqueous liquid composition comprising significant concentrations of at least two bio-available minerals selected from the group consisting of calcium, magnesium, potassium, zinc, copper, iron, manganese, which liquid is palatable and very stable against sedimentation. Typically, the aqueous liquid is stable against sedimentation of the first mineral and the second mineral for at least 1 month when stored at 20° C.

According to a preferred embodiment of the present process, the duration of step c) is in the range of 1-40 minutes. In step e), the biopolymer is advantageously added between 1 and 40 minutes after the addition of the second water-insoluble mineral salt in step d).

Another aspect of the present inventions relates to a reconstitutable powder containing a first mineral selected from the group of metals consisting of calcium, magnesium, potassium, zinc, copper, iron, manganese and a second mineral, different from the first mineral, that is selected from the same group of metals:
0.01-3 mmole, preferably 0.3-2 mmole of the first mineral per gram of powder;
0.02-4 mmole, preferably 0.6-2 mmole of the second mineral per gram of powder;
0.02-8 mmole, preferably 1-5 mmole of acid per gram of powder, said acid being selected from the group consisting of citric acid, tartaric acid, malic acid, phosphoric acid and combinations thereof;
0.02-0.99 g, preferably 0.2-0.99 g of soy protein per gram of powder; and
less than 10 wt. %, preferably less than 2 wt. % of water;
   said reconstitutable powder further being characterised in that 25 grams of the powder can be reconstituted with 1 kg of water to yield an edible aqueous liquid that will not form a salt sediment of the first and/or second mineral when stored under ambient, quiescent conditions for 3 months or longer.

The inventors have discovered that the stability of the supplemented edible aqueous liquid composition is retained even if said composition is dried to a powder and reconstituted again with an aqueous liquid.

According to a particularly preferred embodiment, the first mineral contained in the reconstituted powder is Mg and the second mineral is Ca.

The reconstitutable powder of the present invention advantageously contains 1.1-1.5 mmole of calcium per gram of powder. The amount of magnesium most preferably is within the range of 0.7-1.1 mmole per gram of powder. The amount of acid contained in the powder most preferably is within the range of 2.5-3.1 mmole per gram. The reconstitutable powder of the present invention is advantageously packaged in sealed sachets that protect the powder against moisture. Preferably, each sachet contains 2-20 grams of the powder. A plurality of sachets containing the reconstitutable powder of the present invention is suitably packaged in a single container (e.g. a box), said container carrying instructions to dissolve the contents of a single sachet in 50-500 ml of an aqueous liquid.

According to a particularly preferred embodiment, the reconstitutable powder contains 0.5-5 mmole of citric acid per gram of powder.

In accordance with another preferred embodiment, the reconstitutable powder contains 1-50 wt. % of a polysaccharide selected from the group consisting of pectin, carrageenan, alginate, carboxymethyl cellulose, xanthan, gellan gum and combinations thereof.

The reconstitutable powder of the present invention advantageously contains 10-90 wt. %, more preferably 40-70 wt. % of fruit solids.

Yet another aspect of the invention relates to a method of preparing a reconstitutable powder that has been supplemented by at least two different minerals, said method comprising preparing a supplemented aqueous liquid composition by means of the method defined herein before, followed by drying the edible aqueous liquid composition obtained by said method. In order to dry the aqueous liquid composition use can be made of any drying technique known in the art, such as spray drying, drum drying, freeze drying etc. Preferably, the drying of the edible aqueous liquid composition comprises spray drying and/or freeze drying. Most preferably, the method employs spray drying.

According to yet another advantageous embodiment, the present method yields a reconstitutable powder as defined herein before.

The invention is further illustrated by means of the following examples.

### EXAMPLES

### Example 1

Soy-based beverages were produced on the basis of the recipes described in the following table:

Composition (in wt. %)

| Ingredients | A | B | C | D |
|---|---|---|---|---|
| Soy protein isolate¹ | 1.27 | 1.27 | 1.27 | 1.27 |
| Sucrose | 3 | 3 | 3 | 3 |
| HM pectin | 0.35 | 0.35 | 0.35 | 0.35 |
| Sucralose | 0.01 | 0.01 | 0.01 | 0.01 |
| Fruit concentrates (65 | 3.7 | 3.7 | 3.7 | 3.7 |
| °Brix) | | | | |
| Citric Acid | 0.20 | 0.20 | 0.25 | 0.75 |
| Ca-carbonate² | 0 | 0 | 0.27 | 0.27 |
| Mg-carbonate³ | 0 | 0 | 0.18 | 0.18 |
| Ca-lactate⁴ | 0 | 0.84 | 0 | 0 |
| Mg-lactate⁴ | 0 | 0.63 | 0 | 0 |
| Demi-water | to 100% | to 100% | to 100% | to 100% |

¹ex Solae (FXP 219)
²ex Scora S.A., France (particle size: Passing 325 mesh/45 μm (wet sieve) 98.5%)
³ex Lohmann, Germany (particle size approx. 90% <0.1 mm.)
⁴ex Purac, Netherlands

The soy beverages were prepared by heating the water to 75° C. About 27% of the hot water is used to dissolve the soy protein isolate. The isolate is dispersed through the water with the help of a turrax blender, following which the solution is held for 10 minutes. Next, a dry blend of pectin, sugar, sucralose and maltodextrin is dispersed into the aqueous solution with the help of the turrax blender. Subsequently, the remainder of the water is added under stirring.

In parallel to the above mentioned procedure an acid mineral base was prepared for use in product D, using the following process: Citric acid was added to a portion (appr. 8%) of the total water at a temperature of 10° C. Magnesium carbonate was added under mild stirring. After about half an hour carbon dioxide formation had stopped and the solution reached maximum transparency. Next, calcium carbonate was added under mild stirring. After another half hour carbon dioxide formation had stopped. At this point the solution also reached maximum transparency and was immediately processed further as described below.

Product A was prepared by adding the fruit concentrate and the citric acid to the soy protein solution. Products B and C were prepared by further adding the mineral salts after the fruit concentrate and citric acid had been added. In the case of product D fruit concentrate was added followed by the pre-prepared acid mineral base. The final pH of all four beverages was 4.2-4.3.

Next, the products were pasteurized at 72° C. for 40 seconds (laminar flow) using an indirect heating system. The pasteurized products were homogenised using a single homogenisation step at 175 bar. After hot filling in plastic jars, the products were cooled in cold water and stored at 5° C. without light.

During a storage period of 18 weeks, the products were analysed and evaluated by a test panel. The following analyses and evaluations were performed:

### Redispersibility of Sediment

To determine the redispersibility of sediment a small portion of the product was taken out of the upper part of the bottle using a pipette. With the rest of the content the bottle was shaken rigorously two times. A visual estimation was made of how much of the sediment disappeared after shaking. This was done for samples stored for up to 18 weeks. Mineral sediment is typically poorly redispersible compared to protein sediment.

### Concentration of Calcium and Magnesium in the Sediment

Samples were taken from the top layer (supernatant) of the bottle after 1 day, 3, 6, 12 and 16 weeks of storage. The amounts of calcium and magnesium were measured by Inductively Coupled Plasma Emission Spectrometry.

For this the samples are extracted in dilute hydrochloric acid and the solution is sprayed into the inductively coupled plasma of a plasma emission spectrometer, after which the emission is measured for calcium at 31.933 nm and magnesium at 285.213 nm. The calcium and magnesium content is determined by comparison with a blank and standard solution of these elements in diluted hydrochloric acid (direct method of determination).

The amount of sedimented mineral was calculated with the formula: (the amounts being calculated by multiplying the measured calcium concentration in with the total volume of sample or supernatant):

% of mineral in sediment=((amount of mineral in total sample−amount of mineral in supernatant)/amount of mineral in total sample)×100%

### Taste Paneling

To judge the samples on their taste a test was done with a panel of 15 panel members specifically trained on mineral-fortified soy/fruit beverages. Rigorous shaking to remove any sediment was applied before tasting.

Results

| | | | | | % of | |
|---|---|---|---|---|---|---|
| | | | | % of | total | |
| | | | | total Ca | Mg | |
| Sam- | sediment | | | in | in sedi- | panel |
| ple | properties | | | sediment | ment | result |
| A | <1 | vol. % | completely | — | — | preferred |
| | | | redispersible | | | |
| B | <1 | vol. % | completely | 0 | 0 | not |
| | | | redispersible | | | preferred, |
| | | | | | | metallic, |
| | | | | | | bitter, |
| | | | | | | yoghurt |
| C | appr. 5 | vol. % | Hardly | 80 | 65 | not |
| | | | redispersible | | | preferred, |
| | | | | | | powdery, |
| | | | | | | gritty |
| D | <1 | vol. % | completely | 0 | 0 | preferred |
| | | | redispersible | | | |

### Comparative Example A

Example 1 was repeated to prepare the product D described therein, except that this time the acid mineral base was prepared by simultaneously adding the magnesium carbonate and the calcium carbonate. It was observed that a vigorous reaction occurred between the carbonate salts and the citric acid. During the reaction turbidity gradually decreased, but no clear solution was obtained at any stage. More than an hour after the addition of the carbonate salts, within a few minutes, the aqueous suspension turned very turbid.

### Example 2

A reconstitutable powder containing soy protein, citric acid, calcium and magnesium was produced starting from the premix described in table 3:

TABLE 1
Composition of premix (in wt. %)
pectin base

| | |
|---|---|
| HM pectin | 0.8 |
| Maltodextrin | 2.41 |
| demi water | 25.02 |

soy base

| | |
|---|---|
| sterilised soy extract (ex | 41 |
| SunOpta, 4.2% protein) | |
| demi water | 27.3 |

Mineral base

| | |
|---|---|
| Calcium carbonate¹ | 0.46 |
| Magnesium carbonate² | 0.42 |
| citric acid | 2.11 |
| demi water | 27.78 |

¹ex Scora S.A., France (particle size: Passing 325 mesh/45 μm (wet sieve) 98.5%)
²ex Lohmann, Germany (particle size approx. 90% <0.1 mm.)

The pectin base was stirred at high shear for 20 min at 80° C. After that it was cooled down to below 40° C. The soy base was homogenised at 150 bars. After that, the soy base was added slowly to the pectin base while stirring. After all the soy base had been added, the resulting mixture was stirred under high shear for 30 min.

In parallel, the mineral base was prepared using the following process: Citric acid was added to the total water at a temperature of 10° C. Magnesium carbonate was added under mild stirring. After about half an hour carbon dioxide formation had stopped and the solution reached maximum transparency. Next, calcium carbonate was added under mild stirring. After another half hour carbon dioxide formation had stopped. At this point the solution also reached maximum transparency and a pH of 3.6 was reached. After this it was immediately added to the mixture of the soy and pectin base, which resulted in a pH of 4.1. The bases were mixed for a few minutes under high shear. This was followed by a second homogenisation, 2-stage (180/50 bars).

After this the solution was spray-dried. Inlet temperature was 180° C., outlet 80° C. Nozzle pressure was 3.5 bar. Feed flow rate was 15 kg/h. A powder was obtained with moisture content of approx. 4%. The composition of the powder is depicted in Table 2.

TABLE 2
Composition of powder

| | Wt. % |
|---|---|
| protein | 22.0 |
| HM pectin | 6.6 |
| maltodextrin | 19.9 |
| Citric acid | 17.4 |
| Calcium carbonate | 3.8 |
| Magnesium carbonate | 3.4 |

### Example 3

The powder from example 2 was made into a soy/fruit drink using the recipe of table 3:

TABLE 3
Composition of soy/fruit beverage

| | Wt. % |
|---|---|
| Powder from example 2 | 3.6 |
| Sucrose | 3 |
| Sucralose | 0.01 |
| fruit concentrates (65 °Brix) | 3.7 |
| additional citric acid | to reach pH of 4.1 |
| demi water | to 100% |

The soy beverage was prepared by heating the water to 80° C. In this water the powder from example 2 was dispersed with the help of a turrax blender, following which the solution was held for 10 minutes. Next, a dry blend of sugar and sucralose was dispersed into the aqueous solution with the help of the turrax blender. Next, the fruit concentrate and the citric acid were added. The final pH of the beverage was 4.1.

Subsequently, the product was pasteurized at 72° C. for 40 seconds (laminar flow) using an indirect heating system. The pasteurized products was homogenised using a single homogenisation step at 175 bar. After hot filling in plastic bottles, the products were cooled in cold water and stored in the dark at 5° C.

After a storage period of 16 weeks, the product was evaluated using the techniques described in Example 1 for determining sediment redispersibility, for analysing the percentage of mineral in the sediment and for analysing the taste.

Results

| | | % Ca in | % Mg in | |
|---|---|---|---|---|
| sediment properties | | sediment | sediment | panel result |
| <1 vol. % | mostly | 0 | 0 | Acceptable |
| | redispersible | | | |

1. A method for producing an edible aqueous liquid composition that has been supplemented with a first mineral selected from the group of metals consisting of calcium, magnesium, potassium, zinc, copper, iron, manganese and a second mineral, different from the first mineral, that is selected from the same group of metals, said method comprising the successive steps of:
a. providing an acidic aqueous liquid having a pH in the range of 2.0-4.5 and containing dissolved acid that is capable of forming a water-insoluble salt with the first mineral as well as with the second mineral;
b. adding to the acidic aqueous liquid a solid water-insoluble carbonate salt of the first mineral;
c. allowing the carbonate salt to dicarboxylate until at least 50% of the carbon dioxide potential has been released;
d. adding to the aqueous liquid a solid water-insoluble carbonate salt of the second mineral; and
e. adding a biopolymer groups or increasing the pH by at least 0.5 pH units to a pH of more than 3.4 when both the water-insoluble carbonate salt of the first mineral and the water-insoluble carbonate salt of the second mineral have been converted into dissolved salts and before sedimentation occurs of a water-insoluble salt of the first mineral or of a water-insoluble salt of the second mineral.

2. Method according to claim 1, wherein both the water-insoluble carbonate salt of the first mineral and the water-insoluble carbonate salt of the second mineral are added in an amount that, under the conditions employed during the addition, exceeds the solubility of that salt in the aqueous liquid to which it is added by at least 10%.

3. Method according to claim 1, wherein the first mineral is selected from the group consisting of Mg, Zn, Cu, Fe and Mn.

4. Method according to claim 3, wherein the first mineral is Mg.

5. Method according to claim 1, wherein the second mineral is selected from the group consisting of Ca and K.

6. Method according to claim 5, wherein the second mineral is Ca.

7. Method according to claim 1, wherein the acid is selected from the group consisting of citric acid, tartaric acid, malic acid, phosphoric acid and combinations thereof.

8. Method according to claim 1, wherein the solid water-insoluble carbonate salt of the first mineral that is added during step b) has a number weighted mean particle size that is at least 100% larger than the number weighted mean particle size of the solid water-insoluble carbonate salt of the second mineral that is added during step d).

9. Method according to claim 1, wherein the biopolymer is selected from the group consisting of protein and anionic polysaccharide.

10. Method according to claim 1, wherein the biopolymer is added in an amount of at least 1 g/l.

11. Method according to claim 10, wherein the biopolymer is added in an amount of 5-100 g/l

12. Method according to claim 1, wherein the intermediate product obtained from step d) is characterised in that sedimentation of mineral salts will occur if the product is kept under quiescent conditions at a temperature of 20° C. for up to 24 hours.

13. Method according to claim 1, wherein the edible aqueous liquid composition is stable against sedimentation of the first mineral and the second mineral for at least 1 month when stored at 20° C.

14. A reconstitutable powder containing a first mineral selected from the group of metals consisting of calcium, magnesium, potassium, zinc, copper, iron, manganese and a second mineral, different from the first mineral, that is selected from the same group of metals:
0.01-3 mmole of the first mineral per gram of powder;
0.024 mmole of the second mineral per gram of powder;
0.02-8 mmole of acid per gram of powder, said acid being selected from the group consisting of citric acid, tartaric acid, malic acid, phosphoric acid and combinations thereof;
0.02-0.99 g of soy protein per gram of powder; and
less than 10 wt. % of water;
said reconstitutable powder further being characterised in that 25 grams of the powder can be reconstituted with 1 kg of water to yield an edible aqueous liquid that will not form a salt sediment of the first and/or second mineral when stored under ambient, quiescent conditions for 3 months or longer.

15. Reconstitutable powder according to claim 14, wherein the first mineral is Mg and the second mineral is Ca.

16. Reconstitutable powder according to claim 14, wherein the powder contains 0.5-5 mmole of citric acid per gram of powder.

17. Reconstitutable powder according to claim 14, wherein the powder contains 1-50 wt. % of a polysaccharide selected from the group consisting of pectin, carrageenan, alginate, carboxymethyl cellulose, xanthan, gellan gum and combinations thereof.

18. A method of preparing a reconstitutable powder that has been supplemented with at least two different minerals, said method comprising drying an edible aqueous liquid composition obtained by a method according to claim 1.

19. Method according to claim 18, wherein the drying of the edible aqueous liquid composition comprises spray drying.

20. (canceled)
